(19) United States
(12) Patent Application Publication
(10) Pub. No.: US 2007/0196578 A1
(43) Pub. Date: Aug. 23, 2007

(54) Method and system for coating

(76) Inventors: Michael Karp, Petah Tikva (IL); Zeev Savion, Kibbutz Hanita (IL); Semenduev Aida, Kibbutz Hanita (IL); Avigdor Bieber, Ra'anana (IL)

Correspondence Address: PEARL COHEN ZEDEK LATZER, LLP, 1500 BROADWAY 12TH FLOOR, NEW YORK, NY, 10036, US

(21) Appl. No.: 11/547,913

(22) PCT Filed:
(86) PCT No.: PCT/IL05/00400

(51) Int. Cl. B05D 1/40; B05D 3/02; B05D 3/00

(52) U.S. Cl. 427/331; 427/384

(57) ABSTRACT

A method for coating two substrates, face to face (F2F), simultaneously, by laminating the two substances while encapsulating coating material as a thin film in between the first substrate and the second substrate. Then the coated material is conditioned into solid or partial solid layer. Later the two substrates are separated for creating two coated substrates the first coated substrate and the second coated substrate.

### BACKGROUND

1. Field of Invention

The invention relates to the field of coating apparatus and methods, and more particularly to coating by lamination.

2. Description of Background Art

Popular coating methods include methods such as but not limited silkscreen, wire-wound rod, offset coating, anilox roller, reverse roll, air blade, gravure, etc. Those methods suffer from a plurality of disadvantages. For example, in order to create homogenous, smooth and uniform coating, the viscosity of the coating fluid is limited. Common viscosity of thin layer coating fluid is lower than 100 cps. Therefore common coating fluid is diluted before it is coated over a substrate. The coating fluid may be diluted by water or organic solvent, depending on the chemical nature of the coating fluid. In case of diluting the coating fluid, drying system may be needed in order to evaporate the additional water/solvent. The drying system cost money and floor space. In addition drying consumes energy and may create ecological problems.

Current coating methods create flaws that affect the surface of the coated layer. Some of the coating flaws create structures having uniform appearance such as ribbing, cascade or orange peel. Other flaws create non-uniform appearance such as blade streaks. The coating flaws are function of the nature of the coating fluid as well as the setting of the coating device. The smoothness of the coated layer is mandatory in case of using the coated layer as the surface of a printing plate. Any flaw or artificial structure over the surface of a printing plate, specially a periodical structure, will be transferred to the printed-paper. One approach for reducing the coating flaws and improving the smoothness of the surface of the coated layer is reducing the viscosity of the coating fluid by dilution.

Coating methods, such as coating by ironing lamination of a form film (release film) or wet lamination method of a form film such as the methods that were disclosed in PCT application number PCT/IL03/00652, which was published on Feb. 19, 2004 having the international publication number WO04/014651, the content of which is incorporated herein by reference, may overcome some of the limitation of traditional methods. For example, the coating by ironing lamination method of a form film may overcome the need for diluting the coating fluid since higher viscosity fluid may be used.

There is a need for a system and a method for coating in which the coating surface will be less sensitive to the rheological nature of the coating fluid as well as the setting of the coating device or to conditions at the interface of the coating layer. This will reduce the cost of coating systems and improve the quality of the coated surface. Further more there is a need to use 100% solid coating fluid that will be totally converted to solid at the end of the coating process without creating ecological problems. The new method will improve the smoothness of the coating surface and will reduce it's production cost.

### SUMMARY OF THE DISCLOSURE

Exemplary embodiments of the present invention solve the above-described problems by providing less expensive coating method in which the surface of the coated layer, at the end of the process, is a smooth plane parallel to the substrate. During the coated process this surface plane is located in the bulk of the coating fluid and not at the interface of the coating fluid. For example, the surface plane may be located in the center of the bulk of the coating fluid. Therefore, during the coating process the final coating surface is less sensitive to the conditions at the interfaces of the coating material, at both sides. As result the new method is less sensitive to ambient conditions, rheological nature of the fluid and the setting of the applying device. The surface of the coated layer, which is produced according to exemplary embodiments of the present invention, is smooth and free of structures such as ribbing, orange peel, or cascading. Furthermore the quality of the surface is achieved by non-expensive system.

We have discovered that when homogeneous coating fluid is applied in between two substrates, a first substrate and a second substrate, laminating the two substrates as a sandwich while capturing coating fluid in between them. Curing the coated fluid and then separating the two substrates in constant tearing conditions. The cured coating material will be tom along a virtual tearing line, which is parallel to both substrates and perpendicular to the tearing forces providing two coated substrates. Typically, the tearing line may be in the center of the sandwich of cured coating layer. The new-coated method is referred, in the disclosure of the present invention, as Face To Face (F2F) coating method.

We have discovered that in order to reach good results by using the F2F coating method, the adhesion forces between the cured coating layer and each one of the substrates has to be stronger than the cohesion forces in the cured coating layer. Furthermore, the mechanical strength of each one of the substrates has to be stronger than the cohesion forces in the cured coating layer.

We have disclosed that the F2F coating method may be used for producing printing plates. For example, when at least one of the substrates, which is used for producing the printing plate, has different affinities for ink than the coated layer, which is the top layer of the printing plate, and the at least one of the substrates has a laser-absorbing layer in between the substrate and the top coated layer. If both of the substrates have those features, the F2F method may produce two printing plates at the same time. For example a printing member, which is disclosed in PCT application number PCT/IL2003/00652, the content of which is incorporated herein by reference, may be produced also by using the F2F method. It should be noted that the terms “printing member” and “printing plate” are used interchangeably throughout the specifications and the claims.

For producing such an exemplary printing plate, at least one substrate may have a base layer and a imaging layer. The base layer may be a polyester layer having ink-accepting oleophilic properties. Other non-limiting examples of oleophilic base layer may be polyvinylchloride (PVC and polycarbonate film. The thickness of the oleophilic base layer may be, for example, in the range of 0.001 inch to 0.02 inch. The imaging layer may be a gradient solid dispersion of one or more metals and one or more metal-oxides forming a metal/metal-oxide layer (MMO), as it is disclosed in PCT application PCT/IL2003/00652.

Other exemplary printing plate that may be produced by exemplary embodiments of the present invention may have image sensitive components in the coating fluid. For example, the image sensitive components may be laser absorption components such as but not limited to carbon black particles. Other types of printing plate may be exposed by other radiation sources. For example, UV imaging, thermal imaging or visible light imaging may be used.

Furthermore, we have disclosed that the F2F coating method may be used for producing ready to print printing member having an image. For example, when one of the substrates, which will be referred as the printed substrate or the imaged substrate, was printed imagewise by image carry material (ICM), prior to the coating stage. The ICM may be ink or toner, for example. Imaging the printed substrate may be done by an inkjet or a laser electro photographic printer, for example. Wherein the printed substrate and the ICM may have the same affinity for ink and/or to ink-repellent fluid. Moreover, both of them have different affinity to ink and/or to ink-repellent fluid than the coated layer. The coated layer is the top layer of the printing plate. The second substrate, which is referred as the tearing substrate, is used for tearing the coated layer and revealing the ready to print printing member having the image. Wherein the image has different affinity to ink and/or to ink-repellent fluid than the non-imaging areas, which are covered by the coating material.

PCT patent application number PCT/IL2004/000519, the content of which is incorporated herein by reference, discloses a method for producing a ready to print printing member by using an Image Transfer Film (ITF). The ITF is used as a transfer media on which the image is printed by a computerized printer. Later, the ITF is laminated over a printing plate, transferring the printed image into the printing plate. While using the F2F method for producing a ready to print printing member, the ITF is replaced by the printed substrate. The printing substrate has strong adhesion forces to the coating material.

We have discovered that for producing ready to print printing member, the thickness of coating layer between the two substrates may be set to a larger distance than the height of the ICM image over the printed substrate and less than twice this height. Furthermore, it is recommended that the cohesion of the ICM or the adhesion of the ICM to the coating material, after curing, will be weaker than the cohesion of the cured coating layer.

In other embodiments of the present invention that may be used for preparing ready to print printing plate, the imaging process may imagewise create areas having different adhesion of the coating material to one of the substrates (the imaged substrate) than the non-imaged areas. After separating the coated sandwich, if the adhesion of the coated layer to the imaged substrate, in the imaged areas is less stronger than the cohesion of the coated layer, then during separating the two substrates, the imaged coated layer will be removed revealing the imaged substrate. At the end of the separating stage the coated imaged substrate may have two types of areas, coated areas and uncoated areas according to the image. The two type of area have different affinity to ink or to ink repellent fluid.

In cases where the imaging radiation improves the adhesion of the coating material to the imaged substrate then at the end of the separating stage the coated imaged substrate may have two types of areas, coated areas and uncoated areas according to the image, which are the inverse of the previous case. The two type of area have different affinity to ink or to ink repellent fluid.

Other exemplary embodiments of the present invention may be used for coating substrate that can be used for applications other than printing plates. For example, the F2F method may be used to produce release liner, to coat a protective layer on top of sensitive surface such as but not limited to flexible optical filters. Other exemplary embodiments of the present invention may be used for producing anti-graffiti coatings, etc.

Other objects, features, and advantages of the present invention will become apparent upon reading the following detailed description of the embodiments with the accompanying drawings and appended claims.

### BRIEF DESCRIPTION OF THE DRAWINGS

FIG. 1a illustrates relevant elements of an exemplary apparatus that may be used for coating substrates according to an exemplary embodiment of the present invention;

FIG. 1b emphasizes a virtual tearing line in the apparatuses of FIG. 1a;

FIG. 1c illustrates relevant elements of another exemplary apparatus divided into two parts that may be used for coating substrates according to another exemplary embodiment of the present invention;

FIG. 1d illustrates relevant elements of another exemplary apparatus having inspection system;

FIG. 2 is an enlarged sectional view of an exemplary printing member that has been coated according to exemplary embodiment of the present invention;

FIG. 3 is an enlarged sectional view of another exemplary printing member having a primer;

FIG. 4 illustrates an exemplary apparatus that may be used for fabricating a ready to print printing member according to other exemplary embodiment of the present invention having an imaging system;

FIG. 5a is a schematic top view of an imaged portion over a printed substrate, after imaging;

FIG. 5b is A-A′ sectional schematic view of the exemplary printed substrate of FIG. 5a;

FIG. 5c is an enlarged schematic sectional view of the marked area ‘B’ in FIG. 5b;

FIG. 6a is a schematic top view of a sandwich comprising the imaged portion of the printed substrate of FIG. 5a laminated over a coated layer and a tearing substrate;

FIG. 6b is C-C′ sectional view of the sandwich of FIG. 6a;

FIG. 6c is an enlarged schematic sectional view of the marked area ‘E’ in FIG. 6b;

FIG. 7a is C-C′ sectional view of the sandwich of FIG. 6a, upside down, before separating the two substrates;

FIG. 7b is a sectional view of the sandwich of FIG. 7a while separating the two substrates;

FIG. 7c is a sectional view of the two substrates after separating them; and

FIG. 7d is a top view of the two substrates after separating them.

### DETAILED DESCRIPTION OF VARIOUS EMBODIMENTS

Turning now to the figures in which like numerals represent like elements throughout the several views, exemplary embodiments of the present invention are described. For convenience, only some elements of the same group may be labeled with numerals. The purpose of the drawings is to describe exemplary embodiments and not for production. Therefore dimensions of components and features shown in the figures are chosen for convenience and clarity of presentation and are not necessarily shown to scale.

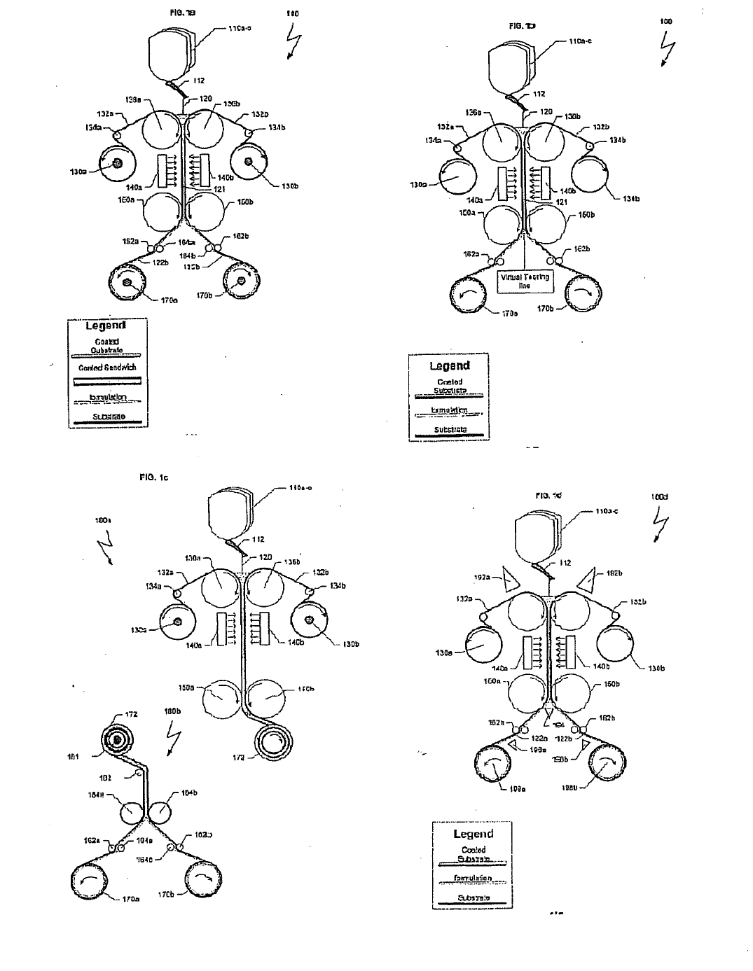

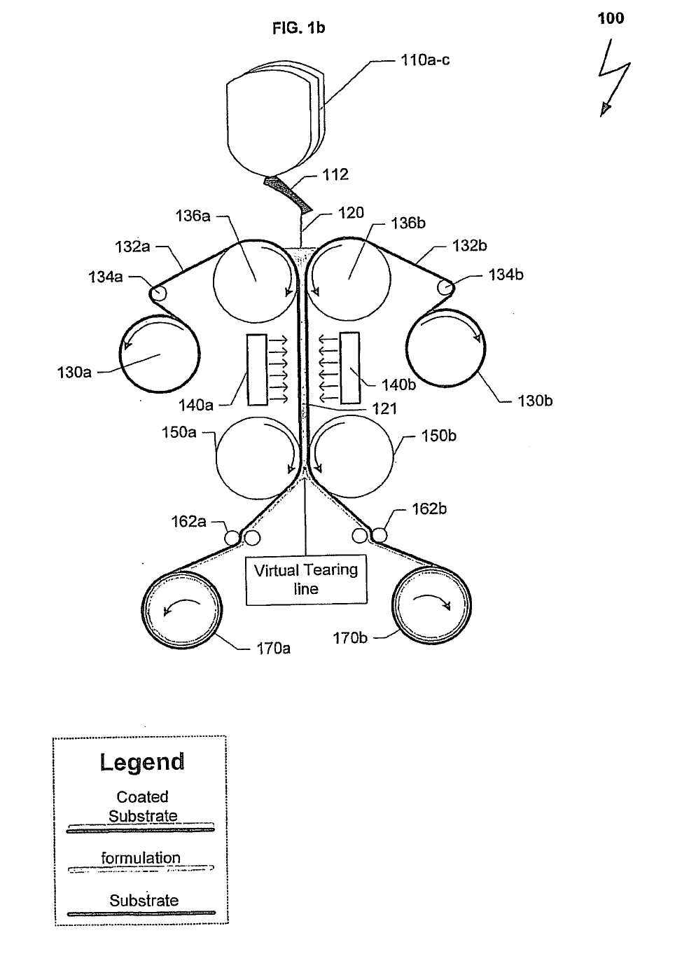

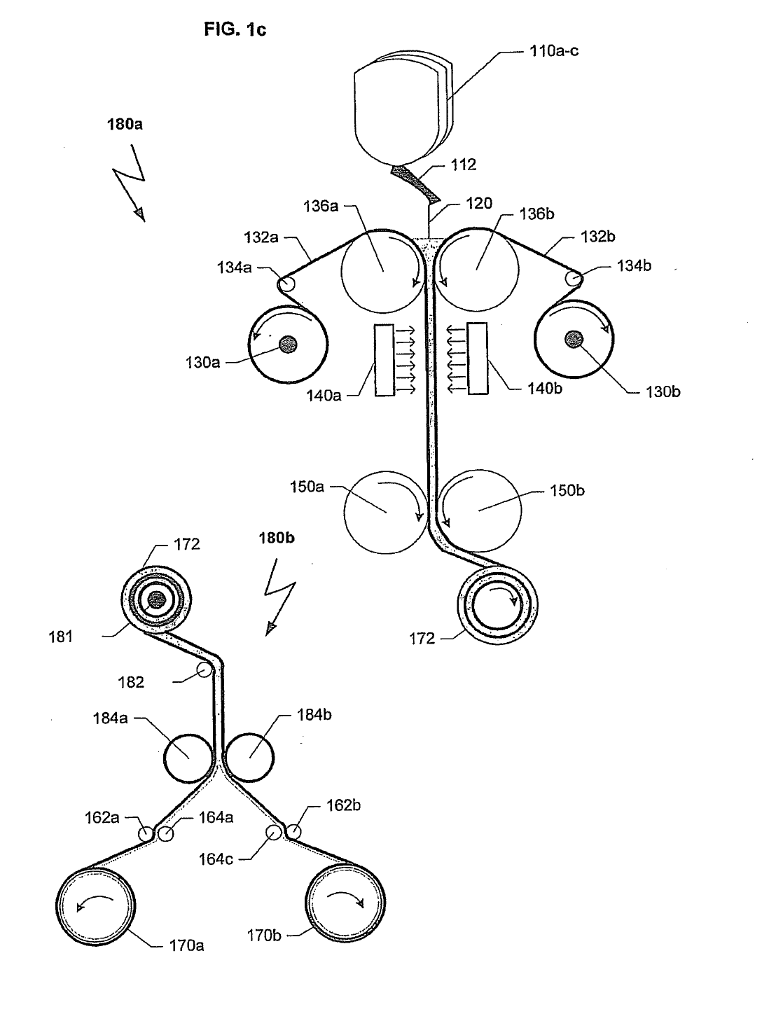

Reference is now made to FIG. 1a, which is a schematic cross sectional view of an apparatus for coating one or two substrates, simultaneously, according to exemplary embodiments of the present invention. A coating system 100 may comprise two substrate-feed rollers, a first substrate-feed roller 130a able to carry a first substrate 132a continuously wound in the form of a roll, a second substrate feed roller 130b able to carry a second substrate 132b continuously wound in the form of a roll, guiding rollers 134a, 134b, 136a, 136b, 150a, 150b, 162a &b to advance unwound substrates 132a & 132b in a predetermined direction at a controlled speed, tension and separating angle, and accumulating cylinders 170a and 170b for accumulating the two coated substrates 122a and 122b (respectively). FIG. 1a does not illustrate the actuating controlled motors and the controllers of the apparatus 100.

According to other embodiments of the present invention, the substrates rollers may be replaced by substrate sheets feeder (not shown in the drawings). In those embodiments the substrate transferring mechanism (e.g. rollers 130a, 130b, 134a, 134b, 136a, 136b, 150a, 150b, 162a, 162b, 170b and 170b) may be replaced by sheet transferring mechanism. Apparatus 100 may be divided into feeding section (cylinders 130a&b and 134a&b), coating section (from cylinders 136a&b to 150a&b), separating section (cylinders 150a&b, cylinders 162a&b and 164a&b) and accumulating section (cylinders 170a&b).

It should be understood to a person skilled in the art that the scope of the present invention is not limited to the illustrated substrates transferring system. System 100 may comprise any number of guiding rollers and pulling cylinders. Alternatively, other transferring mechanisms, as known in the art, may be used. For example, other embodiments may use buffer mechanism between the feeding subsystem and the applying cylinders 136a&b at the entrance of the coating section. Buffers may also be used between the separating sub system (cylinders 150a&b, 162a&b and 164a&b) and the accumulating rollers 170a&b. The buffers may be used to isolate the coating section from the rest of the apparatus. Other embodiments of the present invention may add web-cleaning mechanism as part of the feeding section.

System 100 may comprise an adjusting mechanism (not shown). The adjusting mechanism may be used to set the distance between cylinders 136a&b. This distance is set according the required thickness of the coated layers over both substrates. In some embodiments of the present invention applying cylinders 136a&b may include heating source in order to control the temperature of the coating formulation at the entrance to the coating section. The heating source may be used for formulation that comprises thermoplastic components.

In other embodiments of the present invention the adjusting mechanism may also set the separating section, the distance between rollers 150a&b, the location of the two sets of cylinders 162a&164a and 162b&164b. The relative location between the two sets themselves and/or the relative location of the two sets, together as one unit, to rollers 150a&b affect the tearing parameters. The tearing parameters may be the amplitude of the tearing forces, the angle between the tearing forces and the tearing speed. It may also influence the distance of a virtual cutting line from each one of the substrates.

The location of the two sets of cylinders 162a&164a and 162b&164b may be set over both sides of a symmetrical line as it is illustrated in FIG. 1a. The symmetrical line is laid in the center of the coating material 121 along the coated section of the device 100. In such a case the radiuses of cylinders 150a&b may also affect the tearing parameters. In other cases (not sown) the separating section may be located in one side of the symmetrical line, on the right side or the left side of the symmetrical line. In such a case both coated substrates 122a&b embrace one cylinder, 150a or 150b, and tangent the second one 150b or 150a respectively (not shown in the drawings).

Other embodiments of the present invention may comprise a cutting mechanism (not shown) as part of the accumulating section instead or in addition to one or both rollers 170a&b. The cutting mechanism may cut one or both coated substrates into coated sheets according to the required specifications. One or more trays may be added to receive the coated sheets. Cutting unit may cut the roll in both dimensions into sheets having a predefined length and width. Alternatively the cutting mechanism may cut a certain length of coated substrate that is rewind by the take-up roller 170a&b.

Many types of substrates 132a&b may be coated by coating apparatus 100. Substrates 132a and 132b may be the same or different types of substrates. The substrates may be in the shape of roll or sheets. Exemplary substrates that can be coated by apparatus 100 may include polymer, metal or paper in the shape of roll or sheet.

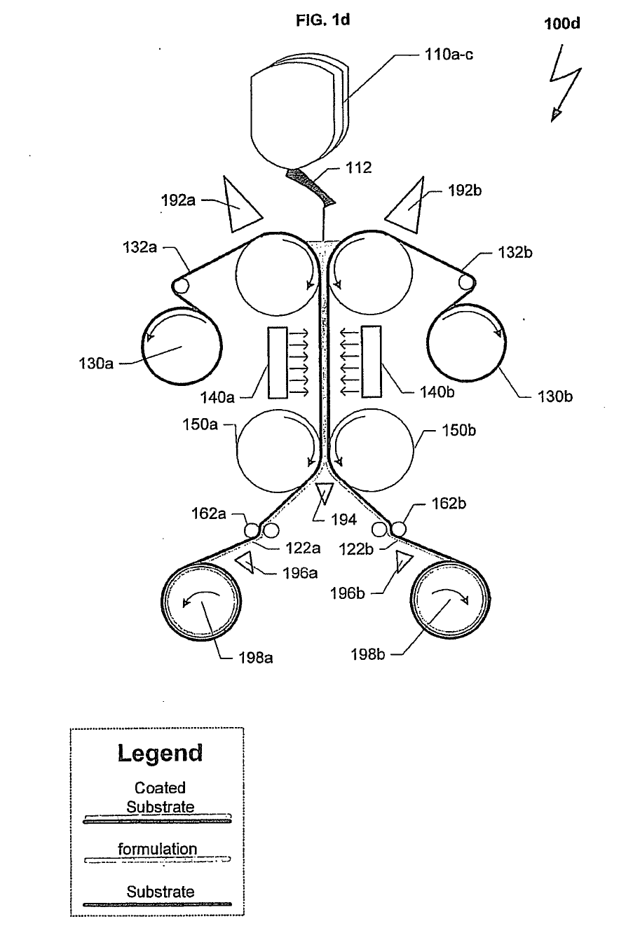

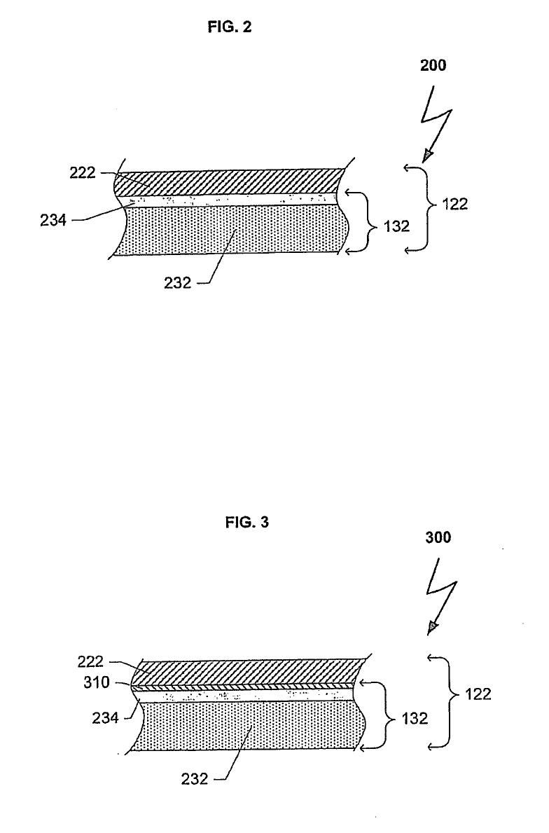

In case that the coating system 100 is used for producing printing plates, substrates 132a and/or 132b may further comprise an imaging layer and/or primer layer. The imaging layer may be a gradient solid dispersion of one or more metals and one or more metal-oxides forming a metal/metal-oxide (MMO) layer where at least some of the areas may be characterized by a non-stoichiometric ratio between the metal and the oxygen, as it is disclosed in PCT application number PCT/IL03/00652, which was published on Feb. 19, 2004 having the international publication number WO04/014651, the content of which is incorporated herein by reference. Exemplary embodiments of substrates 132a&b are described hereinbelow with respect to FIGS. 2 & 3. In other exemplary embodiments of the present invention the coating material may include imaging sensitive ingredients.

In case that system 100 is used to produce ready to print printing member, one of the substrates 132a or 132b may previously been imaged with an image that has to be printed later by using the ready to print printing plate. As it is disclosed in PCT application number PCT/IL2004/00519 having the international publication number WO2004/110758, the content of which is incorporated herein by reference. Exemplary embodiments of substrates that are used for producing ready to print printing plate are described hereinbelow with respect to FIGS. 4 to 7d.

Other embodiments (not shown) of the present invention may be adopted to handle substrate sheets instead one or both substrate rollers. In those embodiments the appropriate feeding section may be replaced from a roller feeding mechanism to a sheet feeding mechanism. The coating section may include one or more conveyors to carry the substrate sheets along the coating section. The separating section may be replaced by sheet separating mechanism. The sheet separating mechanism may include clamping mechanism with separating device, for example. The accumulating section may be one or more trays instead of roller.

Coating system 100 may further comprise a formulation preparing section to prepare on-demand the coating material 120 and to apply the coating material onto substrates 132a&b. The formulation preparing section may comprise one or more cartridges 110a-c, each able to contain separately one or more ingredients of the coating formulation and an applicator 112 to mix the ingredients and to apply the material in between substrates 132a&b forming a coating layer in-between the two substrates. Applicator 112 may comprise a slot, a manifold or a single aperture through which the liquid coating material may be applied. The formulation preparing section may further comprise a controller (not shown) to control the quantities of each component. The formulation preparing section may include one or more heat sources in order to control the temperature of the formulation.

Although three cartridges 110a-c are shown in FIG. 1, it should be understood to a person skilled in the art that the scope of the present invention is not limited in this respect and system 100 may comprise any suitable number of cartridges.

In the coating section of device 100 one of the substrate (i.e. 132a or 132b) is laminated onto the other substrate (i.e. 132b or 132a respectively) such that the liquid coating material 120 is trapped between the two substrates 132a&b to create the laminated sandwich.

System 100 may comprise one or more conditioning units 140a&b. Each conditioning unit may be associated with one of the substrates 132a&b respectively. Different types of conditioning units 140a&b may be used by the present invention, for example ultraviolet (UV) curing lamp to condition the coating material, an infrared (IR) heater, or convection heater, a cooler for cooling the coating material, etc. Other exemplary embodiments of the present invention, which may use coating material that is based on thermoplastic ingredients, may not use conditioning units at all. Other embodiment of the present invention may partially cure the formulation by elements 140a&b, later, after separating the laminated sandwich additional one or more conditioning units (not shown) may be added to finish the curing of the coated layer onto its associated substrate. Other embodiments of the present invention may use a combination of two or more types of curing methods. It should be noted that the verbs “condition” and “cure” are used interchangeably herein.

An exemplary coating process of substrates 132a&b may start when the coating material 120 may be prepared by dispensing predetermined quantities of ingredients contained in multiple-compartment cartridge 110a-c and mixing them into a liquid-based coating material in applicator 112. In other embodiments of the present invention the coating material may be prepared in advance and may be delivered in one cartridge. Substrates 132a&b may be unwound as feed rollers 130a&b are rotated, in substantial synchronization. The coating material, which is a fluid may be applied to or poured over unwound one or both substrates 130a&b. The fluid may be poured at a predefined flow over one or both substrates 130a&b in proximity to the junction of rollers 136a&b where both substrates 130a&b converge.

In alternative embodiments the coating material may be applied over unwound one or both substrates 130a&b in proximity to the junction of rollers 136a&b where both substrates 130a&b converge, instead of the liquid formulation 120. In further exemplary embodiment of the present invention the coating material may be coated over one or both substrates in advance prior to the lamination stage.

Both substrates 130a&b may be fed between guide rollers 136a&b together with the coating material 120. Rollers 136a&b may adhesively press substrate 130a onto substrate 130b such that the coating material is encapsulated as a thin film in between substrate 130a and substrate 130b to form laminated sandwich 121 having the coating material. The thickness of the coating material may be the sum of the required thickness of the coating layer on each one of the substrates. An exemplary thickness of laminated sandwich 121 may be in the range between 1 and 10 microns. According to some embodiments of the present invention, the thickness of the laminated sandwich may be less the one micron. According to other embodiments of the present invention, the thickness of the laminated sandwich may be more than 10 micron.

In an alternate exemplary embodiment of the present invention (not shown in the drawings) the coating material may be thermoset resin, such as but not limited to acrylic or polyester. In another embodiment of the present invention the coating material may be thermoplastic material, such as but not limited to wax, polyvinyl acetate, etc.

In the exemplary embodiments of the present invention the temperature between the guide rollers 136a&b may be controlled according to the requirement of the coating material.

It should be understood, however, to a person skilled in the art, that the scope of the present invention is not limited to coating by the ironing lamination method described above and other coating methods such as for example wet lamination may be used. In the wet lamination method, system 100 may comprise a coating element (not shown). Non-limiting examples of such a coating element may be a silkscreen, a wire-wound rod, an offset coating unit, an anilox roller, an air blade and a gravure roller, etc.

The coating element may be installed in proximity to one or both substrate-feed mechanisms, for example close to roller 134a or 134b. The coating element may receive the coating material and may create a substantially uniform coating layer, over substrate 132a or 132b respectively, having predefined desired properties prior to the lamination operation.

The laminated coated sandwich 121 may then be conditioned by one or more conditioning elements 140a&b. The conditioning elements 140a&b may be an Ultraviolet lamp or any other suitable conditioning method. Non-limiting examples of suitable conditioning methods may include thermal conditioning. The curing may be complete curing, converting the coating fluid 120 into a solid coating layer. In other embodiments of the present invention the curing may be partial curing, wherein the coating layer in laminated sandwich 121 is in-between fluid to solid. In those embodiments of the present invention, additional one or more conditioning elements may be added (not shown) after separating the two coated substrates 122a&b (e.g. between rollers 150a&b and the sets of 162a/164a and 162b/164b).

The conditioned or partial conditioned sandwich is then guided by rollers 150a&b into the separating section (output of cylinders 150a&b, cylinders 162a&b and 164a&b). At the separating section the coated laminated sandwich is separated into two coated substrates 122a&b along a virtual tearing line, as it is illustrated in FIG. 1b. The virtual tearing line is parallel to both substrates and perpendicular to the tearing forces, providing two coated substrates 122a&b. The coated substrates 122a&b have a coated layer with smooth surface. Typically, the tearing line may be in the center of the cured laminated sandwich 121 along the symmetrical line of the coating section. The distance of the virtual tearing line from each one of the substrate may be a function of setting the different elements of the separating section of apparatus 100 as well as the tearing speed, and tearing forces.

The coated substrates 122a&b may be rewound to coated rolls by take-up roller 170a&b respectively. Alternatively the coated substrates 122a&b may be guided by roller 162a/164a and 162b/164b into cutting units (not shown) instead of the take-up rollers 170a&b. The cutting units may cut the coated substrates 122a&b into sheets at a desired size and the sheets may be delivered into trays.

According to some embodiments of the present invention, substrates 132a and/or 132b may be laminated over a metal base, such as, for example aluminum, to improve the mechanical strength of the printing member.

According to some embodiments of the present invention, system 100 may be a part of a printing machine having an on-press imaging unit. According to other embodiments of the present invention, system 100 may be a part of a direct computer-to-plate (CTP) machine.

FIG. 1c illustrates another exemplary embodiment of the present invention. The exemplary coating system in FIG. 1c is divided into two devices: a coating device 180a and a separating device 180b. Elements of this embodiment, which have similar functionality to elements previously described with respect to FIG. 1a, are similarly designated and will not be further described. The coated sandwich at the output of the coating section (e.g. at the junction of cylinders 150a&b) of device 180a is guided to be rewinding over a take-up roller 172. The coated sandwich roller may be rest for a period of time for releasing stresses that were built during the coating (laminating) process. After the resting period the roll of coated sandwich 172 may be loaded on the separating device 180b. The coated sandwich may be guided via cylinders 182, 184a&b to the separating section comprising cylinders 162a/164a, 162b/164b and 170a&b. The operation of the separating section of device 180b is the same as the separating section of device 100.

FIG. 1d illustrates another aspect of an embodiment the present invention. The exemplary coating system 100d emphasizes several inspection and feedback elements that may be added to an exemplary coating system that is built according to embodiment of the present invention. Elements of this embodiment, which have similar functionality to elements previously described with respect to FIG. 1a, are similarly designated and will not be further described. Inspection elements 192a&b may be installed over the substrates 132a&b before the coating section. Elements 192a&b may be video camera or line scanners that may search for defects over the substrates 132a&b. Defects such as dust particles, scratches etc. Upon detecting defects system 100d may stop the coating process and turn on an indication to an operator requesting the operator's interaction.

Sensing element 194 may be a video camera, a line scanner or a CCD sensor that looks over the virtual tearing line. The output of the sensing element 194 may feed a control system of the separating section of system 100d in order to control the location of the tearing line.

Inspection elements 196a&b may be installed over the coated substrates 122a&b. Elements 196a&b may be video cameras or line scanners that may search for flaws over the coated substrates 122a&b. The output of the inspection elements 196a&b may feed a controller of the accumulating section. The accumulating section 198a&b may accumulate a desired length of good-coated substrate, cut the substrate and rewind the desired length of coated substrate over a roller. Upon detecting a flaw in the coated substrate by inspection element 196a or 196b, the controller of the accumulating section may cut the coated substrate, throw away the portion of the accumulated coated substrate with the flaw and may start accumulating again the coated substrate. Using the inspection elements may improve the yield of the coating system 100d and will reduce the cost of the coated substrate.

FIG. 2 illustrates different layers of exemplary printing member according to some embodiments of the present invention. The exemplary printing members 200, which may be produced by system 100, comprises a substrate layer 132 and a coating layer 222. The substrate 132 may have a base layer 232 and an ablatable layer (e.g. leaser absorbing layer such as but not limited to an MMO layer) 234.

FIG. 3 is similar to the embodiment of FIG. 2, except that substrate layer 132 may further comprise a primer 310 above the laser-absorbing layer 234. The primer 310 layer is used to improve the adhesion of the coating layer 222 to the substrate 132. It should be understood that the printing plates, which are described with respect to FIGS. 2 & 3, are exemplary only and do not limit the scope of the present invention and additional layers may be added to those structures. Also, throughout the specification and the claims, the description “a first layer over a second layer” does not exclude having one or more intermediate layers interposed between the first and the second layer.

Base layer 232 may be a plastic film having ink-accepting oleophilic properties. Non-limiting examples of oleophilic base layer 232 may be polyvinylchloride (PVC), polycarbonate and polyester film. The thickness of the oleophilic layer 232 may be, for example, in the range between 0.001 inch and 0.02 inch.

A coating material may be applied on substrate 132 to form the coating layer 222. The coating material may be prepared on-demand for a single use. Coating layer 222 may be an ink-repelling oleophobic layer comprising vinyl terminated polydimethyl silioxanes or silicones epoxy oligomer or silicone acrylate oligomer.

It should be note that the adhesion forces between the coated layer 222 and the ablatable layer 234, or the primer layer 310, if exist, are stronger than the cohesion forces in the coated layer 222. Furthermore, the mechanical strength of substrate 132 is stronger than the cohesion forces in the coated layer 222.

### EXAMPLES

There may be many variations to the formulation of the coating material, some of which are given, by way of illustration only, to show certain aspects of the formulations according to some embodiments of the present invention without limiting its scope. In the following examples of the coating formulation, component designations are in weight percentages.

### Example 1

### For Coating a Substrate

Exemplary substrates: Two matt transparent 175 mc polycarbonate sheets Macrofol DE 6-4, manufactured by Bayer, Leverkusen, Germany, laminated face to face using the containing mixture of following formulation:

| Weight % | Ingredients of the coating material |
|---|---|
| 33 | Polyethylene Glycole diacrylate, sold under the trade name |
| | of SR 610 by Sartomer Company, Exton, USA |
| 13 | Acrylate monomer, sold under the trade name of Photomer |
| | 4003 by Cognis, Cincinnati, USA |
| 16 | Octyl and decyl acrylate mixture, sold under the trade name |
| | of ODA by UCB Surface Speciments, Brussels, Belgium |
| 21 | Acrylate monomer, sold under the trade name of Photomer |
| | 8127 by Cognis, Cincinnati, USA |
| 5 | Tertiary octylacrylamid, sold by Alco Chemicals, |
| | Chattanooga, USA |
| 10 | Acrylated adhesion promoter, sold under the trade name of |
| | Sartomer 9051 by Sartomer Company, Exton, USA |
| 1.3 | Photoinitiator, sold under the trade name of Darocur 4265 |
| | by CIBA Specialties, Tarrytown, USA |
| 0.7 | Carbon Black, sold under the trade name of Printex U by |
| | Degussa AG, Frankfurt, Germany |

Exemplary coated layer thickness may be in the range of 2-5 microns. Exemplary curing conditions: Radiation of UVA Black Light lamp, Eversun L40/79 K of Osram, providing radiation energy 150 mJ/cm2.

Exemplary separating conditions: Peeling with the linear speed about 0.5 m/sec.

### Example 2

### For Producing Processless Thermal Ablative Waterless Plates

Exemplary substrates: metalized polyester films B18812, manufactured by Hanita Coating LP of Israel, laminated face to face using the coating material, containing mixture:

| Weight % | Ingredients of the coating material |
|---|---|
| 90 | Solventless additional cured silicone, sold under the trade |
| | name of Silcolease 11362 by Rhodia, Mississauga, USA. |
| 6.4 | Crosslinker, sold under the trade name of XL 96A by Rhodia, |
| | Mississauga, USA. |
| 3.6 | Platinum catalist, sold under the trade name of CATA 12070 |
| | by Rhodia, Mississauga, USA. |

Exemplary coated layer thickness may be in the range of 1.5-5 microns.
Exemplary curing conditions: temperature of 130° C. for 2 minutes.
Exemplary separating conditions: Separating at speed of 2 m/sec.

### Example 3

### For Coating a Substrate

Exemplary substrates: metalized polyester films B18812, manufactured by Hanita Coating LP of Israel, laminated face to face at 70° C. using melted polyethylene glycol with molecular weight 2000, as coating material. An exemplary polyethylene glycol with molecular weight 2000 is sold under catalog No 29,590-6 b y Sigma-Aldrich Israel Ltd., Rehovot, Israel.
Exemplary coated layer thickness may be in the range of 2-10 microns
Exemplary conditions for solidification: cool to 25° C.
Exemplary separating conditions: Separating at speed of 1 m/sec.

We have discovered that in order to provide smooth separation, cured, or partially cured, coating material should have elasticity and strength properties to allow achieving desirable stress profile with sharp tear force concentration strongly on the virtual tearing line (FIG. 1b). Furthermore, we have discovered that the surface quality of the coated layer may depend also on the separation speed. For example, in the case of example ‘3’ above, fast separation (more than 1 m/sec) is needed for producing good surface. Slow separation (less than 0.5 m/sec) may provide non-regular, rough surface. On the contrary, in the case of example ‘1’ above, slow separation (less than 1 m/sec) is needed for producing good surface. Fast separation (more than 1.0 m/sec) may provide non-regular, rough surface.

An exemplary method may be used for searching the optimized setting for apparatus 100 (FIG. 1) for a certain combination of type of substrate and coating formulation. The method may search for the best curing, or partial curing, conditions before separating the two coated substrates. The curing conditions may influence the cohesion forces in the layer as well as the elasticity nature of the cured material before separating the two substrates.

Then a search for the optimized separating parameters may be initiated, by different setting of the separation section of device 100. The separating parameters may include parameters such as but not limited to speed, tension and angle. The setting procedure may be repeated for fine adjustments. There are some cases in which a rest period may be needed between the curing stage and the separation of the two substrates. In those cases the device 100c (FIG. 1c) may be used.

Reference is now made to FIG. 4, which is a schematic cross sectional view of a system 400 for producing ready to print imaged lithographic plates (RTPILP) according to exemplary embodiments of the present invention. Elements of this embodiment, which are similar to elements previously described are similarly designated and will not be further described. RTPILP system 400 may comprise two main sections: an imaging section and a F2F laminating section that laminates an imaged substrate 564 over a separating substrate 422. The exemplary RTPILP system 400 is using a laser electro photographic printer engine, as the engine of the imaging section, for printing an image using Imaging Carry Material (ICM) over continues blank substrate 562 for converting the blank substrate 562 into imaged substrate 564. Other embodiments may use other printing engines, including but not limited to inkjet. Exemplary ICM that may be used by the printing engine is depending on the blank substrate 562 and the type of the printing engine.

RTPILP system 400 may use a common electro photographic laser printer engine. The principle of operation of such an engine is common knowledge and an example engine is disclosed U.S. Pat. No. 3,867,571, the content of which is incorporated herein by reference. The exemplary printing engine in FIG. 4 comprises an electro photographic drum 510, which rotates clockwise via a cleaning station 520 that cleans the remains from electro-photographic drum 510. The cleaning station 520 is followed by recharge station that is depicted by corona device 532. Then the surface of the drum is exposed by a scanning laser beam 542, a long an axis ‘x’ which is parallel to the axis of drum 510. The scanning is done by an optical mechanism 540 according to the image. The laser beam exposes an electrostatic image over the surface of the drum 510.

The electrostatic image over the drum continues through a developing station 550, which contains appropriate ICM (such as electrostatic toner). The ICM are pulled toward the electrostatic exposed areas over the drum. Then the developed drum passes via a transfer station, depicted by coronal 534 and the junction with the web of the blank substrate 562. At this station the blank substrate 562 is in contact with the drum 510. At the junction, the blank substrate 562 receives an electronic discharge from corona 534 and induces transfer of the developed image to the blank substrate 562 converting the blank substrate into imaged substrate 564. Then the remains of the ICM continue to the cleaning station 520 and a new cycle starts.

The blank substrate 562 is supplied from a supply reel 560, passes around guide rollers 570 and through lamination rollers 462 and 430. After the transfer station and before the lamination rollers the imaged substrate 564 may pass a fusing station 580. The fusing station fixes the image over the imaged substrate 564. The fusing level may be adjusted in order to control the adhesion of the ICM to the imaged substrate. Controlling of the fusion may be achieved by controlling the temperature and/or the duration of the fusing. Other embodiments may use other means for fusing, such as but not limited to drying, UV radiation, etc.

There are cases in which the required adhesion of the ICM to the imaged substrate 564 has to be lower than the cohesion of the coating material 454. In those cases the ICM will be pull out during the separating stage revealing the surface of the imaged substrate according to the image. The imaged substrate has different affinity to ink and/or to ink-repellent fluid than the coating material. In other cases the adhesion of the ICM to the imaged substrate are set to be stronger than the cohesion forces of the ICM themselves and stronger than the cohesion of the coated layer. In those cases the ICM will break during the separating stage creating a surface having ICM areas and coated areas, which have different affinity to ink and/or to ink-repellent fluid.

More information of the imaging section, and the ICM is disclosed in PCT application number PCT/IL2004/00519 having the international publication number WO2004/110758, the content of which is incorporated herein by reference. The patent application discloses a method for producing a ready to print printing member by using an Image Transfer Film (ITF). An embodiment of the present invention may use an imaged substrate instead of the ITF. The imaged substrate will carry the image during the press process.

The imaging section of RTPILP system 400 is ended after the fusing station 580 and the F2F lamination section is started. In the F2F lamination section the imaged substrate 564 is F2F laminated over a separating substrate 422 encapsulating the coating material 454. In some embodiments of the present invention one or more buffers may be used between the imaging section and the F2F laminating section. In other embodiments of the present invention the imaging section may be separated from the laminating section. Other embodiments of the present invention may use imaged substrate that is in the shape sheets and not a roll.

The F2F laminating section of the exemplary system 400 comprises separating substrate feed roller 410 able to carry the separating substrate 422 continuously wound in the form of a roll, guiding rollers 430, 440, 462, 152a, and 152b to advance unwound substrates 422 & 564 in a predetermined direction at a controlled speed, tension. System 400 may be ended 4152 in different ways. For example, system 400 may have an accumulating cylinder at the output 4152 for accumulating the sandwich of the two coated substrates, the separating substrate 422 and the imaged substrate 564 into a roll of sandwich coated imaged substrates. The roll of the sandwich coated imaged substrates may later be transferred to a separating unit, such as unit 180b in FIG. 1c. Other embodiments of the present invention may have a separating unit added at the end 4152 of the lamination section after the rollers 152a&b as in FIG. 1a. The separating unit may separate the two substrate into a coated imaged substrate and a coated separating substrate. The coated imaged substrate may be cut into imaged ready to print plates. Exemplary cutting methods are disclosed in the PCT application number PCT/IL2004/00519 having the international publication number WO2004/110758, the content of which is incorporated herein by reference.

More information on the F2F lamination section is disclosed above in conjunction with FIG. 1a to 1d. It was discovered that for using the F2F laminating section to coat the imaged substrate 564, the thickness of the coated layer, in between the two substrates 422 and 564, may be less than twice the height of the ICM over the imaged substrate 564 and more than the height of the ICM over the imaged substrate 564. The laminating section of system 400 has to be set accordingly.

Keeping the thickness of the coated layer in the above range and the mechanical strengths of the substrates, ICM and the coating material as well as the adhesion of the coating material and the ICM to the substrates, as it is disclosed above, leads the virtual tearing line (FIG. 1b), during the separating stage, to tear the ICM together with the coating material delivering two coated substrates.

After separating the two substrates, the surface of the coated imaged substrate 564 has two types of areas, areas that are covered with the ICM (according to the image) and areas that are covered by the coating material. Both areas have different affinity to ink and/or to ink-repellent fluid. The coated separating substrate 422 has no other functionality and it may be throw away. The coated imaged substrate may be cut into imaged ready to print printing members.

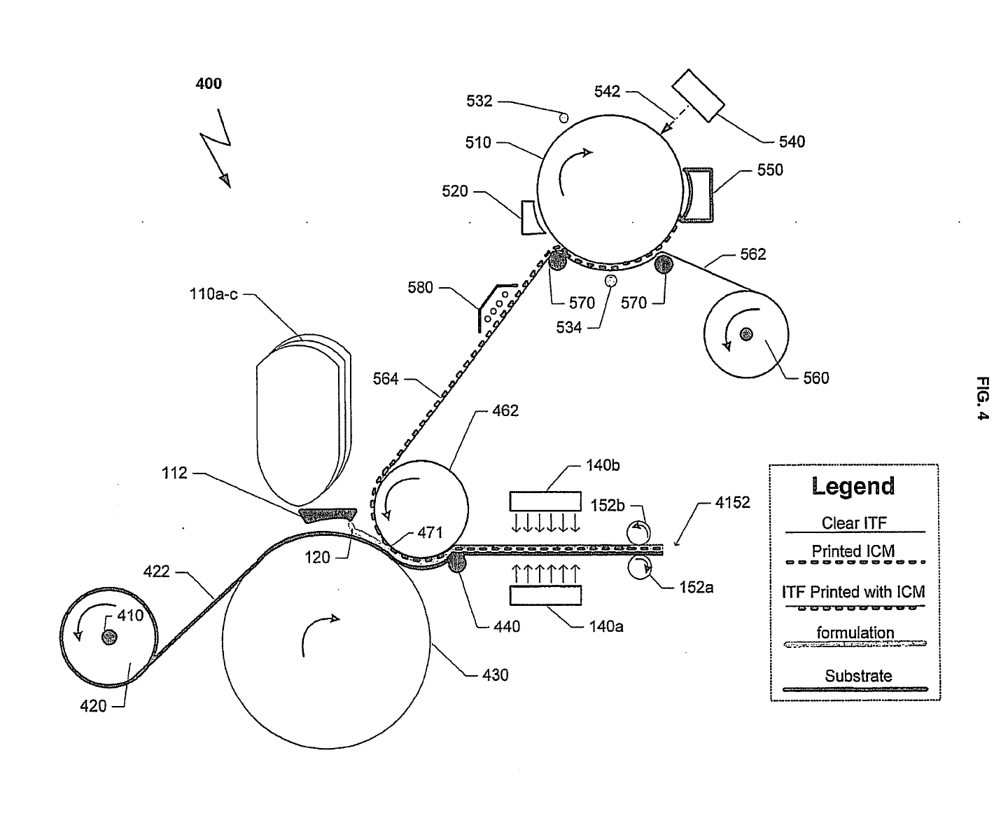

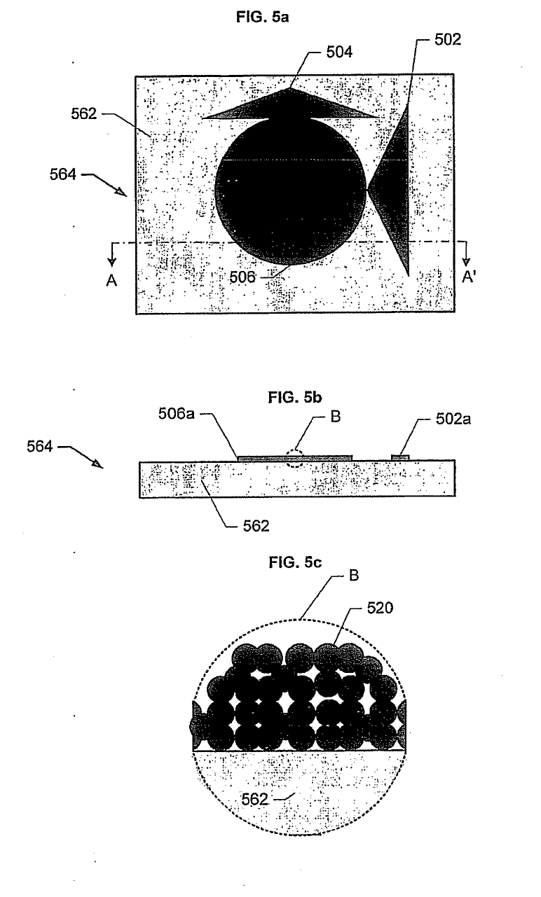

FIG. 5a is a schematic top view of an imaged portion over a section of imaged substrate 564, after the imaging stage. Imaged substrate 564 comprises of a blank substrate 562 that is used as a substrate on which the images 502, 504, 506 were exposed. Imaging may be done by a common computer printer, using common technology, such as but not limited to: Electro Photographic (electrostatic printers), Inkjet, Ionographia, and Wax Thermal Transfer etc. Later, imaged substrate 564 is laminated over a separating substrate 422, creating sandwiched coated imaged substrates.

The exemplary printed image in FIG. 5a includes a circle 506 with two triangles, one 522 on the right side of circle 506 (from the reader's point of view) and the other triangle 504 on the top of the circle 506. The exemplary Image Carry Material (ICM) that is used in this example is black toner manufactured by HP. Other exemplary embodiments may use other type of ICM. The ICM properties depend on the type of the printer that is used, the imaged substrate and the required ink affinity property.

Other exemplary ICM may be solution or melt able resin, such as but not limited to acrylate, polyester, vinyl resins etc. The solution may be used in an inkjet printer, for example. Other exemplary embodiments of the present invention may first laminate the sandwich of the two substrates and the coating material and then using the conditioning stage also for imaging. The conditioning may be done by laser UV according to the image, for example. In such embodiments UV curable acrylate compound may be added to the coating formulation.

FIG. 5b is a sectional side view of imaged substrate 564 illustrating the ICM areas, 506a & 502a, along the line A-A′ of the circle 506 and the triangle 502 respectively. FIG. 5c is enlarged area ‘B’ in FIG. 5b illustrating the fixed ICM 520 over substrate 562. Fixing may be done in the printer or outside of the printer. The fixing may be done by several methods, such as but not limited to fusing, curing, drying etc. It should be noted that the terms “fusing”, “fixing”, and “drying” are used interchangeably herein and the henceforth, the description of the present invention may use the term ‘fusing’ as a representative term for any of the above group.

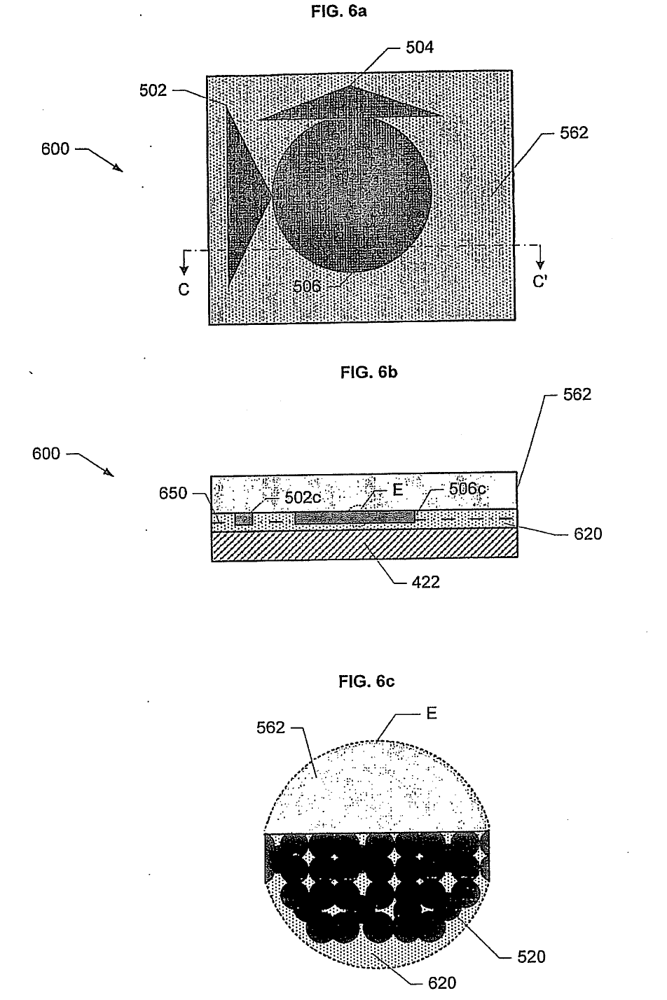

FIG. 6a is a top views of the imaged portion of an imaged coated sandwich of substrates 600. An imaged coated sandwich of substrates 600 comprises an upside-down imaged substrate 562 laminated with coated layer 620 (FIG. 6b) above separating substrate 422 (FIG. 2b). The printed side of imaged substrate 562 is facing down toward layer 620. The ICM in the printed imaged as well as coated layer 620 of the sandwich may be seen through the imaged substrate 562, if the image substrate is transparent. It can be observed that the printed image is the mirror image of the image in FIG. 5a, the triangle 502 appears in the left side of circle 506.

FIG. 6b is a sectional side view of the exemplary imaged coated sandwich of substrates 600 at the end of the laminating stage. The figure illustrates the ICM areas, 506c&502c, along the line C-C′ of the circle 506 and the triangle 502 respectively. The ICM areas, 506c&502c, are dipped inside the coated layer 620. A virtual line 650 illustrates the center of the thickness of coated layer 620. It can be seen that the thickness of the dipped ICM inside the coated layer is more than half of the thickness of the coated layer but less than the thickness of the coated layer 620 itself. An area of ICM 520 inside the layer 620 is emphasized in FIG. 6c, which is enlarged view of the marked area ‘E’ in FIG. 6b. The fused ICM 520 is dipped inside layer 620. The thickness of coated layer 620 may be in the range of 2 to 10 microns.

The imaged coated sandwich of substrates 600 comprising of the separating substrate 422, the coating material and the imaged substrate 562 may undergo conditioning stage to cure the coating material into a solid or partial solid layer 620 fixing the dipped printed ICM 520 into the coated layer.

During curing of the coating material, good adhesion to both substrates 562 & 422 is generated, which is substantial stronger than cohesion forces of the coating material itself. In addition good adhesion of the coating material to ICM 520 is generated, which is substantial stronger than the cohesion forces of the ICM 520 itself.

Other embodiments of the present invention may use other formulation for the coating layer that generate low adhesion forces between the cured coating material and the ICM while the ICM has strong cohesion and strong adhesions to the imaged substrate.

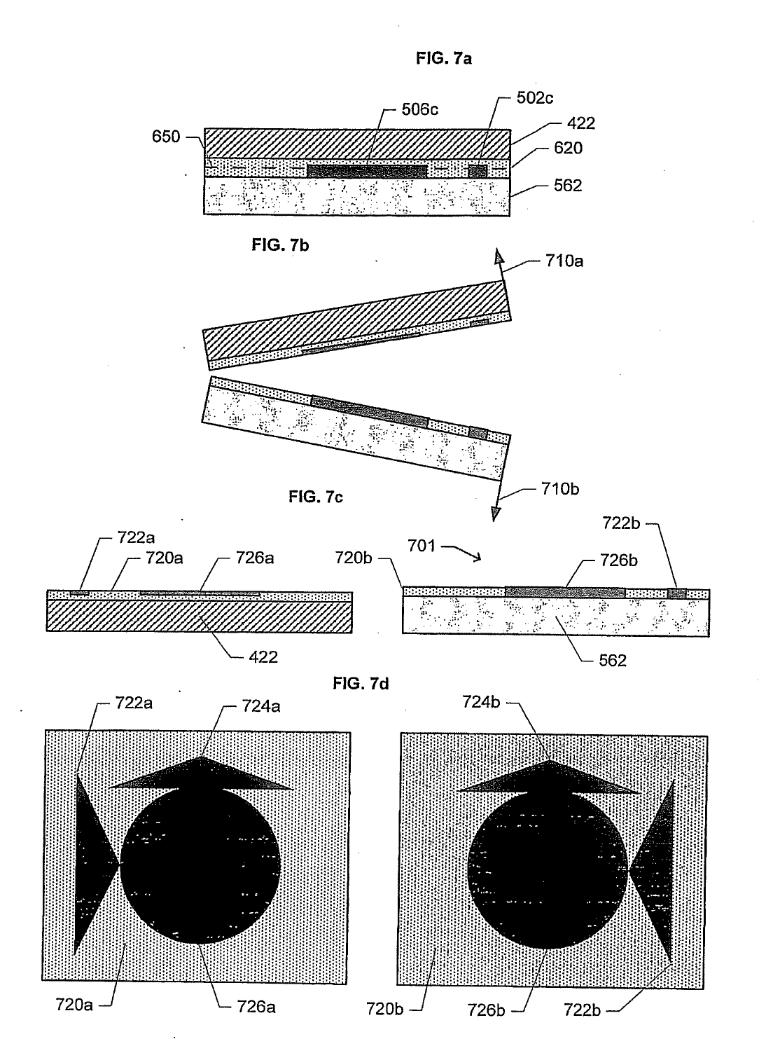

After curing, the imaged coated sandwich of substrates 600 may be separated as it is illustrated in FIG. 7a-d. FIG. 7b illustrates two tearing forces 710a&b that may pull, in a certain angle, speed and power both substrates tearing the coated layer 620 along a virtual tearing line. Wherein the virtual tearing line is in between line 650, which illustrates the center of the thickness of coated layer 620, and the imaged substrate 562. During typical separating conditions the virtual tearing line and the centerline 650 may be united.

After separating two coated substrates are produced, as illustrated in FIG. 7c &d. The imaged coated substrate 701 having a top smooth surface. The surface of the imaged coated substrate 701 has two types of areas. The first type is made of ICM martial 726 & 722, for example, and the second type 720b is made of the coating material. Both types have different affinity to ink and/or to ink-repellent fluid. In some cases in which the adhesion of the coated layer to the ICM is stronger than the adhesion of the ICM to the imaged substrate, the ICM may be pulled away during the separation of the two substrates revealing the substrate in the imaged areas. In those embodiments the substrate and the coated layer have different affinity to ink and/or to ink-repellent fluid.

The coated separating substrate 422 may have a coated layer 720a. The surface of the coated layer 720a may have areas 722a, 724a & 726a with residues of ICM. The shape and the components of the coated separating substrate are not important since the coated separating layer can be thrown away.

### Example 4

### For Producing Ready to Print Imaged Waterless Plates

Exemplary substrates: metalized polyester films B18812, manufactured by Hanita Coating LP of Israel, printed using HP Laser Jet 4050 laser printer, heated in oven at 110° C. for 2 minutes, and then laminated face to face with another same substrate (not-imaged) using the coating material, containing mixture of following formulation:

| Weight % | Ingredients of the coating material |
|---|---|
| 90 | Solventless additional cured silicone, sold under the trade |
| | name of Silcolease 11362 by Rhodia, Mississauga, USA. |
| 6.4 | Crosslinker, sold under the trade name of XL 96A by Rhodia, |
| | Mississauga, USA. |
| 3.6 | Platinum catalist, sold under the trade name of CATA 12070 |
| | by Rhodia, Mississauga, USA. |

Exemplary thickness of coated layer may be in the range of 2-5 microns.
Exemplary curing conditions: It placed in the oven at 110° C. for 2 minutes.
Exemplary separating conditions: Separating at speed of 2 m/sec.

Overall, this invention provides a low cost coating system that delivers high quality coated surface.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1.-34. (canceled)

35. A coating method comprising:
laminating first and second substrates while capturing a coating material in between the first and second substrates;
conditioning tile coating material to form a solid or partial solid intermediate layer; and
splitting said intermediate layer to separate between said first and second substrate such that each substrate is coated with a respective portion of said intermediate layer, each portion having a substantially smooth surface.

36. The method of claim 35, wherein during splitting of said intermediate layer, adhesion force between the intermediate layer and each of the substrates is stronger than cohesion forces within the intermediate layer further mechanical strength of each of the substrates is stronger than cohesion forces in the coating material.

37. The method of claim 35, wherein the coating material is liquid.

38. The method of claim 35, wherein the coating material is silicone, a thermoset resin or thermoplastic material.

39. The method of claim 35, wherein said coating material comprises wax and laminating said first and second substrates comprises heating the coating material.

40. The method of claim 35, wherein at least one of the substrates is pre-coated prior to laminating the two substrates.

41. The method of claim 35, wherein at least one of the substrates is made of polyvinylchloride (PVC), polyester, polycarbonate or aluminum.

42. The method of claim 35, wherein splitting said intermediate layer comprises splitting said intermediate in constant tearing conditions.

43. The method of claim 35, wherein at least one of the two substrates and the intermediate layer have different affinity to ink or ink repellant fluid.

44. The method of claim 35, wherein the first substrate or the second substrate is covered imagewise with an image carry material and wherein the image carry material and the intermediate layer have different affinity to ink or ink repellant fluid.

45. The method of claim 35, wherein at least of the substrates coated with the intermediate layer being usable as a lithographic printing member.

46. A coated member comprising:
a first substrate; and
a coating layer above the first substrate, wherein the said coated member is manufactured by:
laminating said first substrate and a second substrate while capturing a coating material in between the first and second substrates;
conditioning the coating material to form a solid or partial solid coating layer; and
splitting said coating layer to separate between said first and second substrate such that each substrate is coated with a respective portion of said coating layer, each portion having a substantially smooth surface.

47. The coated member of claim 46, wherein said first substrate and the coating layer have different affinity to ink or ink repellant fluid.

48. The coated member of claim 46, wherein said coated member being usable as a lithographic printing member.

49. The coated member of claim 48, wherein the first substrate comprises a base layer and a laser-absorbing layer over said base layer.

50. The coated member of claim 49, wherein the laser-absorbing layer comprises a gradient solid dispersion of metal/metal-oxide.

51. The coating member of claim 46, wherein the first substrate is covered imagewise with an image carry material and wherein the image carry material and the coating layer have different affinity to ink or ink repellant fluid.

52. The coated member of claim 46, wherein the coating layer comprises silicone.

53. A coating apparatus comprising:
a first substrate feeder to feed a first substrate;
a second substrate feeder to feed a second substrate;
a laminating unit to laminate said first and second substrates while capturing a coating material in between the first and second substrates;
a conditioning unit to condition the coating material into solid or partial solid layer; and
a tearing unit to split said solid or partial solid layer such that the first and second substrates being separated and each substrate is coated with a respective portion of said solid or partial solid layer, each portion having a substantially smooth surface.

54. The coating apparatus of claim 53, wherein the first and the second substrate feeder are substrate-feed rollers.

55. The coating apparatus of claim 54 further comprising a dispensing unit to prepare and to deliver the coating material.
